(19) United States
(12) Patent Application Publication
(10) Pub. No.: US 2003/0177471 A1
(43) Pub. Date: Sep. 18, 2003

(54) System and method for graphically developing a program

(76) Inventors: Yen-Chang Chiu, Taipei (TW); Wen-Shin Chung, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/383,621

(22) Filed: Mar. 10, 2003

(30) Foreign Application Priority Data
Mar. 12, 2002 (TW) 091104670

(51) Int. Cl. G06F 9/44

(52) U.S. Cl. 717/109

(57) ABSTRACT

Disclosed is a system and method for graphically developing an assembly program by use of a flowchart. Programmers conventionally develop programs by writing the programs in various programming languages, thereby increasing the program complexity and resulting in difficult understanding, maintaining and debugging for the programs. The present invention provides a way to develop an assembly program by a flowchart, avoiding directly writing it in a programming language, so as for the programmer as well as the maintainer to easily understand and read the developed program, and reduces the difficulty to develop and maintain the program.

### FIELD OF THE INVENTION

The present invention relates generally to a program development system and method, and more specifically to a system and method for graphically developing an assembly program by use of a flowchart.

### BACKGROUND OF THE INVENTION

There are many programming languages, such as C, assembly and BASIC, are used to develop computer programs. For example, FIG. 1 shows the schematic diagram of writing an assembly program directly in an assembly language, in which the assembly program is write line by line in compliance with the syntax and symbols of the assembly language. Unfortunately, writing programs directly in programming languages can cause a lot of issues. For example, when the program to be developed is large, the programmer tends to make mistakes on the instructions or syntax due to the large number of the instructions and the strict syntax, while the programmer keeps writing the code without recognizing the mistakes thereof, until the program is completed and then tested or executed to find bugs in the code, and thus the program needs to be debugged and modified again and again. Moreover, since the program is too long, it takes very long time to review and modify the program and the debugging process is not easy and error-prone, besides it is very difficult for someone other than the programmer who develops the code to review, modify and maintain the program.

Particularly, when developing a system, traditionally a compiler is employed to write the program for example for a microcontroller, and the code is translated by an assembler, linked by a linker and debugged in a debugger, among which it is based on the line perspective view, i.e., the writing and operating are line by line, and, therefore, even with the introduction of macros, once the system complexity increases or the code gets longer, it imposes enormous loading on the program developer or maintainer, and the program will be difficult to understand and read. The traditional development environment lacks of the ability to develop programs in a more systematically way and to remind the user of potential errors.

The above-mentioned problems are more severe in the development of assembly program for the assembly language is low-level programming language. To make program development simpler and let the programmer find bugs in the program and modify it more easily, to reduce the time spent on debugging and modifications, and to let someone other than the author understand and maintain the program more easily, a new system and method for program development is highly desired.

### SUMMARY OF THE INVENTION

One object of the present invention is to provide a system and method for graphically developing an assembly program, by which graphic interfaces for easy operations are utilized to replace traditional methodology for program development.

According to the present invention, a flowchart system is used to write an assembly program and, as a result, the program is developed more easily and the difficulties in developing, reviewing and maintaining the program due to the traditional methodology in the aforementioned are avoided.

By use of the invented system and method, it not only lets a user develop an assembly program more systematically and increases the program readability thereof, but also induces the function of checking the internal code, counting the machine cycles of a loop or between two program segments, displaying the status of various registers and tracing the codes. According to the present invention, a program development system comprises a library to provide various graphic interfaces to replace program code in lines, a manipulator module to select and merges the various graphic interfaces into a flowchart for a program, and a transformation module to transform the flowchart composed of various graphic interfaces into a code for the program.

### BRIEF DESCRIPTION OF THE DRAWINGS

The above and other objects, features and advantages of the present invention will become apparent to those skilled in the art upon consideration of the following description of the preferred embodiments of the present invention taken in conjunction with the accompanying drawings, in which:

FIG. 1 shows the schematic diagram of an assembly program in an assembly language;

FIG. 2 shows the correspondence between the program code shown in FIG. 1 and graphic interfaces;

FIG. 3 shows a wrong and a correct program code;

FIG. 4 shows testing on a segment-by-segment basis in a flowchart;

FIG. 5 shows counting the machine cycles of the execution in a flowchart;

FIG. 6 shows tracing the change of a register;

FIG. 7 shows the system components for graphically developing a program; and

FIG. 8 shows the perspective view taken by the present invention.

### DETAIL DESCRIPTION OF THE INVENTION

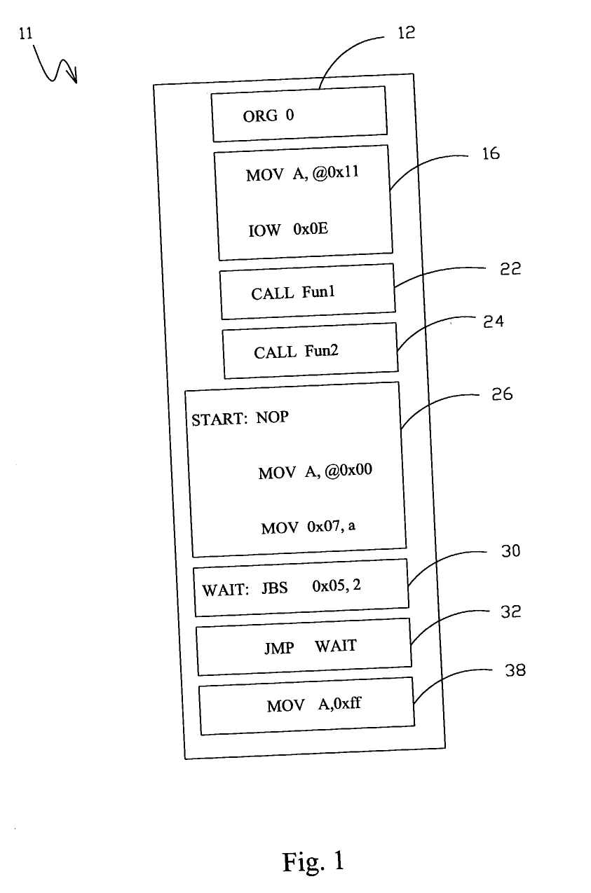

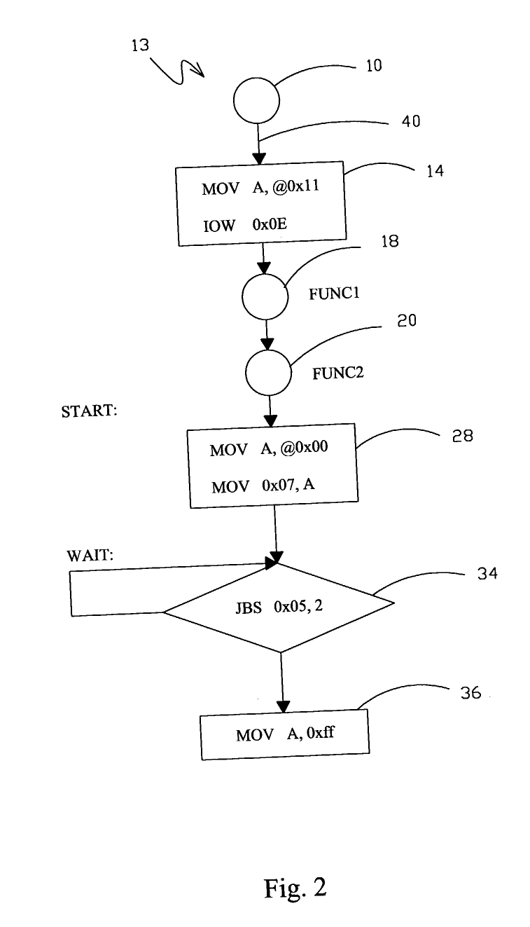

Take the simple assembly program 11 shown in FIG. 1 for instance. According to the present invention, a library that contains a plurality of graphic interfaces is provided in advance, of which each graphic interface corresponds to at least one function or program segment in an assembly language. As shown in FIG. 2, a graphic interface 10 is selected from the library, the code “ORG 0” is fetched as in a program segment 12 corresponding to the graphic interface 10, then a graphic interface 14 is selected, which corresponds to the code “MOV A, @0×11” and “IOW 0×0E” in a program segment 16, next two graphic interfaces 18 and 20 are selected to represent function calls in program segments 22 and 24, respectively, and their corresponding codes are “CALL Funl” and “CALL Fun2”, respectively, the next code “START: NOP” in a program segment 26 indicates an entry point of the execution, represented by the label “START:”, a graphic interface 28 is selected to correspond to the codes “MOV A, @0×00” and “MOV 0×07, A” in a program segment 26, the codes “WAIT: JBS 0×05, 2” and “JMP WAIT” in program segments 30 and 32 indicates the execution will branch to program segment 30 to thereby form a loop and thus a graphic interface 34 is selected to represent the loop, the next graphic interface 36 is selected from the library to correspond to the code “:MOV A, 0×ff” in a program segment 38, and each of the selected graphic interfaces is connected by an arrow 40 to show the execution flow. The flowchart in FIG. 2 is exactly the program 11 in FIG. 1, with each graphic interface corresponding to one of the program segments in the program 11. Then the flowchart 13 composed of those graphic interfaces is translated into the code as in the program 11 by a transformation module, and the program thus obtained is ready for execution on a computer. This manner the program development by a flowchart will be simple, fast and easily achieved.

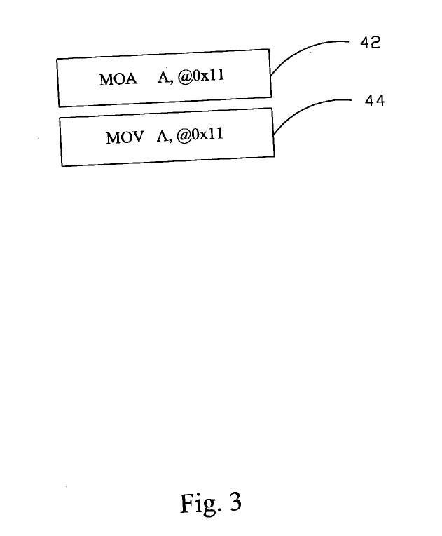

Another application, according to the present invention, is to segment the program into a plurality of program segments and then transform them into a flowchart after the program has been completed. For example, the program 11 in FIG. 1 is transformed to the flowchart 13 in FIG. 2, so as to make the consequent program debugging and reviewing more easily. For instance, when the code contains a wrong instruction, as shown in FIG. 3, in which that the code “MOA A, @0×11” is a wrong instruction, the system will indicate that this instruction is wrong and prompt the correct instruction “MOV A, @0×11” in a program segment 44. For another example, when there exists a branch instruction to jump to an inconsistent interrupt subroutine, to the interior of the subroutine or over the page, the system will issue a warning.

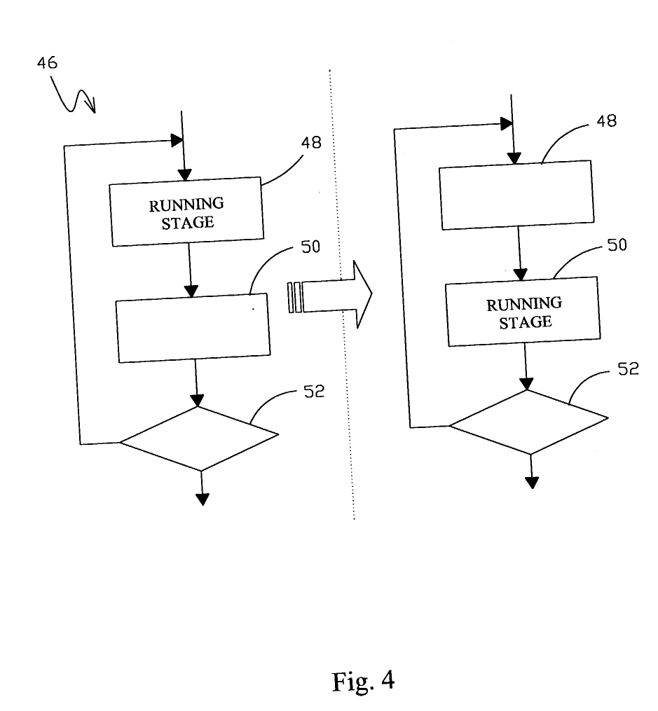

Because the program code is segmented into a plurality of segments, their testing and debugging become easier. As shown in FIG. 4, after the program code is transformed into a flowchart 46, the programmer can sequentially or randomly test the assembly program segment by segment. Graphic interfaces 48, 50 and 52 represent different functions, program segments or instruction sets and are combined together to be the flowchart 46. However, this program 46 can be debugged and checked by use of an arbitration module to judge whether any mistake is existed in an individual program segment. If the programmer desires to test part of the program, he can test the single graphic interface 48 separately and continue the testing of next graphic interface 50 after the completion of testing the graphic interface 48, and testing the rest of graphic interfaces or program segments are performed in the same fashion. In the same manner, a debug module is used to debug or check the code in each program segment individually. The segmentation of the program 46 and the individual test of each program segment 48, 50 and 52 make the debug and check easier.

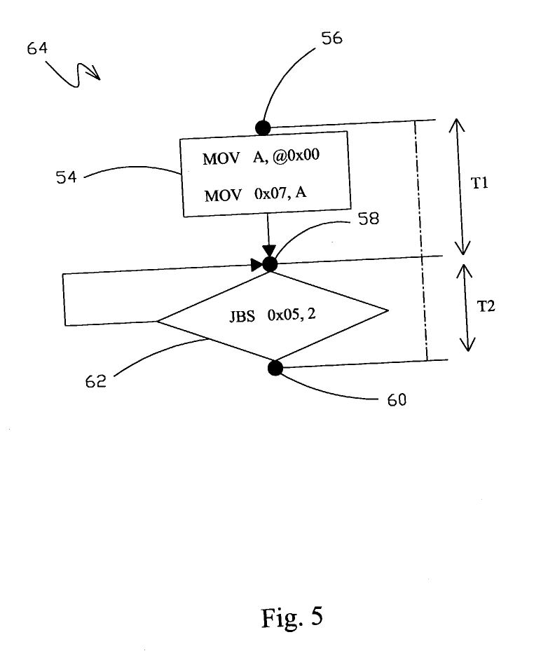

If one desires to count the machine cycles of the program, he can accomplish it by the way as shown in FIG. 5 where upper and lower nodes 56 and 58 of for example a graphic interface 54 in a flowchart 64 are selected and fed to a counter, and the machine cycles T1 between the nodes 56 and 58 of that program segment are obtained. Likewise, if one desires to count the machine cycles of a loop in the program, he selects the upper and lower nodes 58 and 60 of for example a graphic interface 62, and the counter multiplies the loop period Δ T by the loop iteration count N to obtain the machine cycles

T2=ΔT×N.

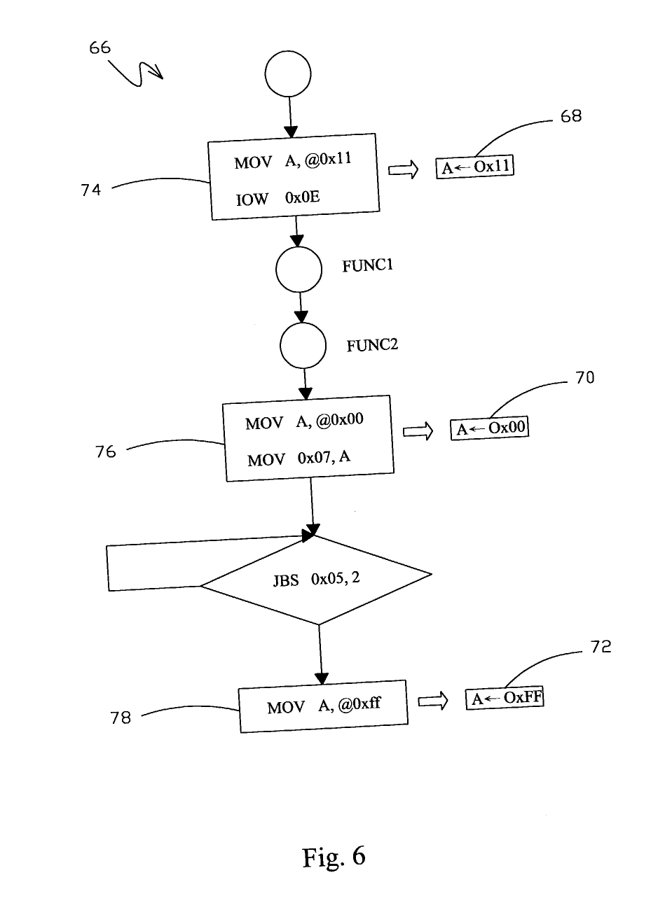

On the other hand, if one desires to trace the content of each register, for example the register A shown in FIG. 6, a trace module can retrieve the content of the register A from the code inputted to the program segments in graphic interfaces 74, 76 and 78, as shown by blocks 74, 76, and 78, and figure out the changes of the register A to determine whether there is any unexpected status.

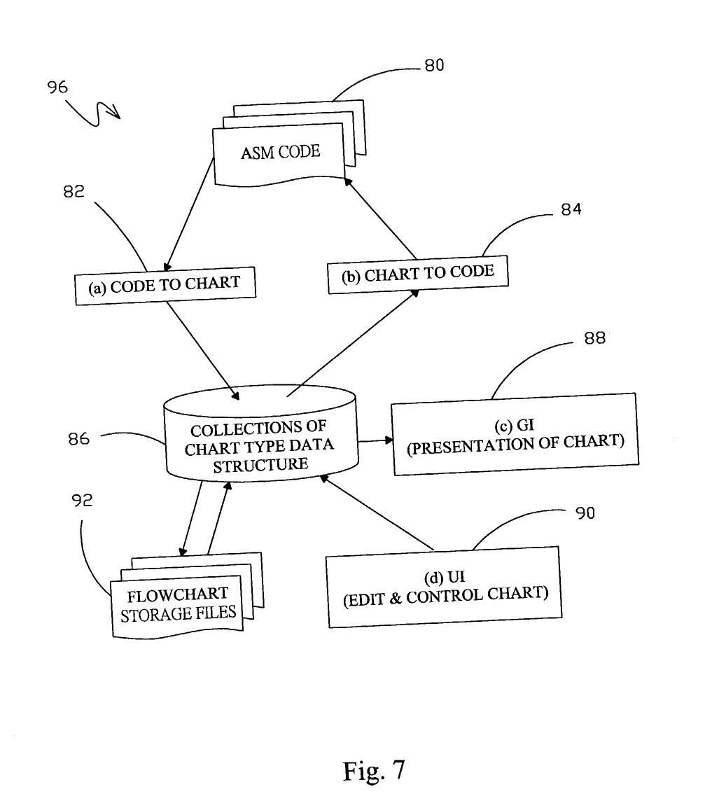

As shown in FIG. 7, a program development system 96 includes four main procedures and employs a predefined graphic data structure 86. A block 80 represents assembly codes, two blocks 82 and 84 represent (a) transformation from a code to a chart and (b) transformation from a chart to a code, respectively, a block 88 represents (c) the completed flowchart based on the collected graphic data structure graphically shown on a computer display, and a block 90 represents (d) capturing the information from the user interface to grasp the user's operations on the graphic interfaces, such as selecting, adding, deleting graphic interfaces. To perform the block 84, a transformation module is provided to transform a flowchart or a chart representing one or more program segments to a code in the assembly language. In contrast, a reverse transformation module is used to transform an assembly code 80 to a flowchart or a chart representing the code 80, which may be a complete program or a program segment. All the charts that are employed in this system to represent functions or program segments and their connections are constructed based on the data structure from the block 86. For the user to develop programs graphically, each graphic interface (GI) representing a function or a program segment or the flowchart composed of such graphic interfaces is graphically shown by a display module in the block 88, i.e., in a presentation of chart, and a manipulator module is provided in the block 90 to edit and control the charts on the display of the display module, by which user interfaces (UIs) are employed to serve as the tool for the user to add, move and delete charts directly on the display. Additionally, the system 96 includes a block 92, which represents storing the graphic data structure in a file or retrieving the data structure 86 from a file. In other words, an assembly program is stored its assembly code in the block 80 and its flowchart in the block 92. The manipulation to the flowchart 92 results in the amendment to the assembly code 80.

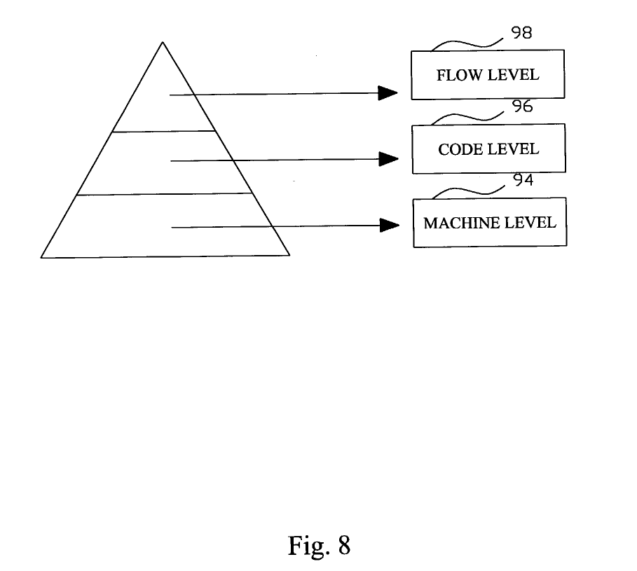

The invented system and method develops an assembly program in a flowchart perspective view, and builds a bridge to the conventional program code, that is, it develops the programming environment in a higher level of abstraction, as shown in FIG. 8, where the lowest level is machine level (machine language) 94, the higher one is code level (programming language) stage 96, and the highest is programming by a flowchart (graphic interfaces) 98. The invented system and method is to develop an assembly program through operations on graphic interfaces, thereby simplifying the development process, increasing reliability, and making the subsequent modification and maintenance easier.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A system for graphically developing an assembly program, comprising:
a library including a plurality of graphic interfaces each corresponding to at least one function or program segment in an assembly language;
a manipulator module for selecting among said graphic interfaces from said library to merge into a flowchart; and
a transformation module for transforming said flowchart into a code in said assembly language for said assembly program.

2. A system according to claim 1, further comprising a reverse transformation module for transforming said code into said flowchart.

3. A system according to claim 1, further comprising a display module for displaying said graphic interfaces and flowchart.

4. A system according to claim 1, further comprising an arbitration module for judging whether instructions, functions or program segments in said code are correct.

5. A system according to claim 1, further comprising a debug module for debugging and checking said code.

6. A system according to claim 1, further comprising a counter for counting machine cycles in said code.

7. A system according to claim 1, further comprising a trace module for tracing registers, memories or program segments in said code.

8. A method for graphically developing an assembly program, comprising the steps of:
defining a data structure for a plurality of graphic interfaces each corresponding to at least one function or program segment in an assembly language;
selecting among said graphic interfaces to form a flowchart for said assembly program; and
transforming said flowchart into a code in said assembly language.

9. A method for graphically developing an assembly program, comprising the steps of:
segmenting a code of said assembly program into a plurality of program segments; and
transforming said code into a flowchart by representing each of said plurality of program segments by a graphic interface.

10. A method according to claim 9, further comprising checking respective said graphic interface in said flowchart.

11. A method according to claim 9, further comprising counting machine cycles between two nodes in said flowchart.

12. A method according to claim 9, further comprising tracing registers, memories or program segments in said flowchart.

13. A method according to claim 9, further comprising transforming said flowchart into said code.
